(19) United States
(12) Patent Application Publication
(10) Pub. No.: US 2025/0107954 A1
(43) Pub. Date: Apr. 3, 2025

(54) CARESS AND THERAPEUTIC MASSAGE APPARATUS AND ASSOCIATED METHOD

(71) Applicant: GRUSZKA CAPITAL, LLC, Sunny Isles Beach, FL (US)

(72) Inventors: David Gruszka del los Rios, Sunny Isles Beach, FL (US); Gilberto Antonio Román Balcone, Barcelona (VE); José Gerardo de Jesús Sánchez Marin, Lecheria (VE); Simón Antonio Díaz Abad, Barcelona (VE); Jósedavid Manzanares Arroyave, Puerto la Cruz (VE)

(21) Appl. No.: 18/976,322

(22) Filed: Dec. 10, 2024

Related U.S. Application Data
(63) Continuation of application No. 17/314,995, filed on May 7, 2021.

(51) Int. Cl. A61H 7/00

(52) U.S. Cl. CPC A61H 7/004; A61H 2201/1215; A61H 2201/14; A61H 2201/1659; A61H 2201/501; A61H 2201/5064; A61H 2201/5071; A61H 2201/5082

(57) ABSTRACT

An apparatus and method for applying caresses and massages, comprising an apparatus composed of a fixed lower section, which acts as a base, contains the lifting mechanisms, and houses a movable upper section, with a housing that accommodates the rest of the components of the device; a SCARA-type deployable robotic arm housed in the upper section and composed by a plurality of staggered parallel links and articulated at their ends by a power transmission mechanism comprised by motors with belts placed on pulleys coupled to concentric hollow shafts. The upper section is placed on a sliding and rotary platform that supports and guides it on the vertical axis through a vertical lead screw lifting mechanism, also allowing it to rotate on its own axis. The apparatus performs the movements by implementing a method of preset caress and massage patterns assisted by artificial intelligence and guided by several sensors.

### FIELD OF INVENTION

The present invention generally relates to the field of robotics, and particularly to collaborative robots and medical robotics aimed to the therapeutic and comfort scope, as well as recreational robotics.

### BACKGROUND OF THE INVENTION

Caress and massage application techniques have been widely utilized for purposes of therapy and comfort. Such techniques, and their use in professional therapeutic fields require a level of understanding of human anatomy and physiology. Also, the use of such techniques requires knowledge of their indications and counterindications.

The synergies between robotic technologies and comfort techniques such as massage therapy, or “structured touch,” allow for the expansion of the use of these techniques to transform and have a positive impact on society, and to address the unmet needs and improve the quality of life of individuals. There is, therefore, an ongoing need to improve the delivery massage therapy to improve the lives of people and to develop more effective and efficient treatment delivery methods utilizing robotic technology.

An example of these technologies are collaborative robots, which consist of devices manufactured to physically interact with humans in a work or home environment, being able to share a space in order to facilitate tasks, improve communication, provide comfort and other tiresome, monotonous, or unpleasant tasks that may benefit the user in general. At present, given the dynamics of modern life, individuals are not always able to use the services of a professional specialized in comfort and massage therapies. Therefore, the need arises to resort to artificial solutions to fill the void left by the lack of human companion, doing the best possible to simulate human touch, and even improve upon it.

In this regard, real implementations in robotics have generated greater credibility in recent years due to improvements in computing power, and state-of-the-art sensors such as cameras or laser scanners that are able to distinguish between the characteristics of a scene that has already been observed and a new one that contains some new features. Thus, sensors collect data, so that robots can take advantage of them in relation to logical patterns.

Currently, there are no commercial robotic devices—in collaborative or medical field—that are being used to perform massages or caresses on the human skin. However, certain approaches have been proposed, but they involve bulky robotic arms with appendages that attempt to simulate a human hand that, at present, lack technical, much less commercial, feasibility.

For the reasons mentioned above, the present invention proposes a proper, technically feasible and economically efficient solution to meet the comfort and well-being needs that afflict a large part of society by adapting caress and massage techniques to the field of collaborative robotics.

### SUMMARY OF THE INVENTION

The present invention is generally directed to an apparatus and method for applying massages and caresses to the skin of the user. More particularly, the design and implementation of a robotic device is provided. The apparatus contains a robotic arm composed of several links sequentially connected by joints. An effector is located at the free end of the last link to hold various accessories adapted to apply massages and caresses according to the needs and instructions of the user.

The general design of the robotic apparatus will determine the efficacy of the invention and thus a basic statement of the main features and design attributes is warranted.

In one embodiment of the invention, a robotic device to perform massages and caresses is provided, comprising a fixed lower section, or housing, which acts as a base, contains the lifting mechanisms of the robotic upper section and electronic components, and serves as a cover for the remaining structure; said movable upper section lifting mechanism is comprised of one or more lead screws on the sides of the fixed lower section passing through a set of linear bearings and connected to supports fixed on the floor of the upper movable section; It also has four rails on the corners that guide the movable upper section and prevent its involuntary descent; and, a movable upper section, called the mast, with a case that integrates the rest of the electromechanical components that make up the device; It is provided with side channels where the rail guides fit and also a cover.

The apparatus also includes a Selective Compliant Articulated Robot Arm (SCARA) with a four degrees of freedom (DOF) range placed on the movable upper section and composed for at least three staggered parallel links and articulated at their ends by a power transmission mechanism made up of motors with belts placed on pulleys coupled to concentric hollow shafts.

More specifically, it comprises a power transmission mechanism that consists of stepper type electric motors on whose shafts belts are connected. At the same time, the belts are coupled to pulleys of different diameters to achieve the reduction rates necessary to obtain the desired torque output. The pulleys are embedded in concentric hollow shafts that allow the power to be transmitted to each link separately. The shafts and pulleys are embedded within a set of bearings to minimize axial and radial stresses. The whole mechanism is rigidly built in between the links by a set of nuts, bolts, and similar fasteners.

Furthermore, it comprises a sliding plate and a rotary base wherein the mast is tightly fixed and supported. The sliding plate comprises anti-friction linear bearings at the corners that aligns the lifting platform within the grooves of the rails that raises and lowers the movable upper section in the vertical axis or z-axis; such plate, in turn, has a rotary base and a pulley arrangement that allows it to rotate around its own axis. Moreover, it has rails that provide stiffness to the structure, prevent buckling and guide the platform in its up and down movement.

Also, in another embodiment of the invention, the movable upper section, or mast, is fully retracted within the fixed lower section, or housing. Conversely, in another embodiment of the invention, the movable upper section, or mast, is completely extended out of the fixed lower section, or housing. This ability to extract and retract allows the device to reduce its height by half, giving it great versatility and portability to be used in limited work spaces without causing discomfort to the user and staying in harmony with its environment.

In another embodiment of the invention, a deployable robotic arm type apparatus is provided, comprising a plurality of staggered parallel links connected sequentially at their ends, with freedom to rotate on the axis of a joint and capable of being automatically deployed from their fully stacked storage position by rotating over their joints until the working position.

In addition, an effector is incorporated at the free end of the last link with a standard coupling wherein several accessories are attached to transmit the massage or caress on the user's skin or other work surface assisted by a module of several optical distance sensors, infrared, laser mapping, among other sensors. Calibration sensors and position sensors are also contained at the articulated end of each link to know and control their movement.

On the other hand, in another embodiment of the invention, the angular movement of the links can be driven directly by a servomotor or by a direct current (DC) brushless motor with harmonic planetary gear reduction box, as well as by motors connected to one or more gears.

In addition, in another embodiment of the invention, in the last link of the deployable robotic arm some element of contact with the work surface can be installed, as well as using any type of position sensors or end-of-stroke sensors.

In another aspect of the invention, a method for the application of massages and caresses on the skin of the user is provided, comprising (a) a user interface, (b) a massage and caress preset patterns library, (c) an image sensor, (d) an image processor, (e) an image segmenter assisted by Artificial Intelligence (AI), visual classification algorithms or any other method that allows image segmentation, (f) an image segmentation process to recognize and isolate the user's back, or other area to massage or caress (g) an adaptation process of the previously selected pattern to the scale and contour of the segmented image, (h) other sensors to collect parameters from the user and the environment, (i) a data processor, (j) a trajectory creator that determines the coordinates that the deployable robotic arm must perform, (k) an inverse kinematics calculation of the trajectory, (l) a motor controller, (m) several motors that drive the deployable robotic arm and (n) motor encoders.

Also, given another representation of the invention, the image sensor can comprise any type of camera, a thermal image camera, a Laser Imaging Detection and Ranging (LIDAR) sensor or any other sensor capable of creating digital images. In addition, in another aspect of the invention, the measurement sensors can comprise any type of distance, proximity, pressure, temperature or magnetic sensor.

In another embodiment of the invention, an image segmentation process used in the method for applying massages and caresses on the user's skin is provided, comprising (a) obtaining the necessary information to create a digital image of the user through an image sensor, (b) classifying the user's position, identifying whether the user is facing back or front, and then segment the area that will receive the massage through the image segmenter assisted by artificial intelligence (AI) and (c) adapting the selected pattern to the scale and contour of the segmented image for performing the movements according to the pattern.

Finally, in another embodiment of the invention, a method for controlling the several motors of the massage and caress therapeutic robot is provided, comprising (a) initialization of the device by the user's input through the user interface, (b) initialization of the processors, controllers and motors, (c) determining the position of each joint of the deployable robotic arm through the motor encoders, (d) verifying if the movable upper section is partially or completely retracted, (e) extracting the entire movable upper section to its working position, (f) unfolding the robotic arm links, (g) choosing a preset pattern, (h) processing the selected pattern; and, finally, (i) executing the pattern; On the other hand, (j) if the user decides not to proceed with an additional massage pattern, (k) placing the deployable robot arm in its stacked position, (l) retracting the upper section, (m) deactivating the processors, controllers, and motors; and, finally (n) ending the method.

In summary, disclosed is a robotic caress and massage apparatus configured to deliver a massage or caress to a user comprising a fixed lower section having a top surface, and a floor, the top surface comprising an opening therethrough; a movable upper section, comprising a base and a vertical axis, the movable upper section adapted to fit within the fixed lower section and to emerge vertically from the fixed lower section through the opening on the top surface of the fixed lower section, the movable upper section further adapted to rotate about the vertical axis relative to the fixed lower section; a selective compliant articulated robot arm (SCARA) comprising a plurality of links, one or more of the plurality of links adapted to rotate about an axis parallel to the vertical axis; an effector removably attached to the robotic arm and adapted to contact the skin of the user; and a movable upper section lifting mechanism adapted to translate the movable upper section and robot arm vertically with respect to the fixed lower section between a stowed configuration and a deployed configuration. It will be understood that the vertical position of the movable upper section can be controlled to be anywhere between the retracted and deployed position, particularly once the robot arm is extended.

In certain embodiments, the movable upper section lifting mechanism comprises a lower section lead screw extending vertically from the floor of the fixed lower section; a selectively activated lower section electrical motor attached to the fixed lower section, and adapted to rotate the lower section lead screw upon activation; and a threaded follower attached to the movable upper section adapted to engage the lower section lead screw.

Some embodiments of the disclosed apparatus further comprise an upper section mast rotating base main pulley attached to the base of the movable upper section; a selectively activated upper section rotation electrical motor and lead screw attached to the fixed lower section; a mast rotating base small pulley engaged with the lead screw, and an upper section rotation belt adapted to engage the mast rotating base small pulley and the mast rotating base main pulley; wherein upon activation of the upper section rotation electrical motor, a rotational motion about the vertical axis is imparted on the movable upper section through the upper section rotation belt.

In some embodiments, the robot arm of the disclosed apparatus comprises an upper link having a proximal end and a distal end; an middle link having a proximal end and a distal end; and a lower link having a proximal end and a distal end; wherein the proximal end of the upper link is adapted to engage the movable upper section; wherein the distal end of the upper link and the proximal end of the middle link form a proximal joint configured to allow the middle link to rotate about an axis of the proximal joint; wherein the distal end of the middle link and the proximal end of the lower link form a distal joint configured to allow the lower link to rotate about an axis of the distal joint; and wherein the effector is attached to the distal end of the lower link.

The robot arm of the present invention can further comprise a selectively activated proximal joint electrical motor attached to the movable upper section; a proximal joint pulley attached to the proximal joint; and a proximal joint belt adapted to engage the proximal joint electrical motor and the proximal joint pulley; wherein upon activation of the proximal joint electrical motor, a rotational motion is imparted on the middle joint about the axis of the proximal joint through the proximal joint belt.

The robot arm of the present invention can also comprise a selectively activated distal joint electrical motor attached to the movable upper section; an intermediate distal joint pulley attached to the proximal joint; a terminal distal joint pulley attached to the distal joint; an intermediate distal joint belt adapted to engage the distal joint electrical motor and the intermediate distal joint pulley; and a terminal distal joint belt adapted to engage the intermediate distal joint pulley and the terminal distal joint pulley; wherein upon activation of the distal joint electrical motor, a rotational motion is imparted on the lower link about the axis of the distal joint through the intermediate and terminal distal joint belts.

The disclosed apparatus, in some embodiments, also comprises a deployment controller for selectively activating the lower section electrical motor to translate the movable upper section between the stowed configuration and the deployed configuration; one or more a robot arm controllers for selectively activating one or more of the lower section electrical motor, upper section rotation electrical motor, proximal joint electrical motor, and distal joint electrical motor to sequentially position the effector into contact with the skin of the user; wherein the sequential positioning of the effector into contact with the skin of the user delivers a massage or caress to the user; one or more a processors adapted to control the deployment controller and the one or more robot arm controllers; a memory adapted to store instructions for controlling the deployment controller and the one or more robot arm controllers; and a user interface for directing the one or more processors to operate the deployment controller and the one or more robot arm controllers in accordance with the instructions stored in the memory.

Additional details regarding the operation of the disclosed apparatus and method are included in the following description which includes non-limiting embodiments of certain aspects of the invention.

### BRIEF DESCRIPTION OF THE DRAWINGS

FIG. 1 is an isometric projection of the caress and massage therapeutic robot in its working position with the robotic arm fully deployed according to one embodiment of the present invention.

FIG. 2 is an isometric projection of the caress and massage therapeutic robot in its working position with the robotic arm fully stacked according to one embodiment of the present invention.

FIG. 3 is an isometric projection of the caress and massage therapeutic robot in its stored position according to one embodiment of the present invention.

FIG. 4 is an isometric projection of the deployable robotic arm fully deployed according to one embodiment of the present invention.

FIG. 5 is an isometric projection of the deployable robotic arm fully stacked according to one embodiment of the present invention.

FIGS. 6A, 6B, and 6C are sequential top views of the deployable robotic arm of FIG. 1 demonstrating the deployment process.

FIGS. 7A and 7B are, respectively, front and side elevational views of the caress and massage therapeutic robot of FIG. 1.

FIG. 8 is an isometric projection of the fixed lower section and its components, according to an embodiment of the present invention

FIGS. 9A and 9B are isometric projections of the top and bottom views of the movable upper section sliding plate and rotating base, according to an embodiment of the present invention.

FIG. 10 is an isometric projection of the movable upper section, or mast, and its components according to an embodiment of the present invention.

FIG. 11 is an isometric projection of the differential power transmission mechanism of the links of the deployable robotic arm according to one embodiment of the present invention.

FIG. 12 is a side view of the differential power transmission mechanism shown in FIG. 11.

FIG. 13 is a top view of the differential power transmission mechanism shown in FIG. 11, also showing the deployable robotic arm according to one embodiment of the present invention.

FIG. 14 is an exploded view of the pulley arrangement used in the differential power transmission mechanism of the links of the deployable robotic arm according to one embodiment of the present invention.

FIG. 15 is a cross-section side view of the caress and massage therapeutic robot according to one embodiment of the present invention.

FIG. 16 is an isometric projection of the caress and massage therapeutic robot of FIG. 1 applying a massage to the back of a user lying on a bed.

FIG. 17 is a schematic representation of a top view of the therapeutic caress and massage robot of FIG. 1 describing its range of work area or workspace.

FIG. 18 is a process flow diagram illustrating the method of applying massages and caresses according to the embodiment of the present invention.

FIG. 19 is a flow chart illustrating the image segmentation process used in the caress and massage method according to the embodiment of the present invention of FIG. 18.

FIG. 20 is a process flow diagram illustrating the method for motor controlling of the caress and massage therapeutic robot according to one embodiment of the present invention.

### DETAILED DESCRIPTION OF THE INVENTION

This description illustrates certain aspects of the invention, and specific embodiments thereof, in greater detail. This description is not intended to be exhaustive, but rather to inform and teach the person of skill in the art who will come to appreciate more fully other aspects, equivalents, and possibilities presented by the invention. The scope of the invention is set forth in the claims, which alone limit its scope.

The embodiments are set forth in the following description and in the attached figures. One skilled in the art will understand that the present invention may be practiced without using all of the details described herein. Moreover, in the description that follows, it is understood that the figures related to the various embodiments are not to be interpreted as conveying any specific or relative physical dimension, and that specific or relative dimensions related to the various embodiments, if stated, are not to be considered limiting unless recited in the claims.

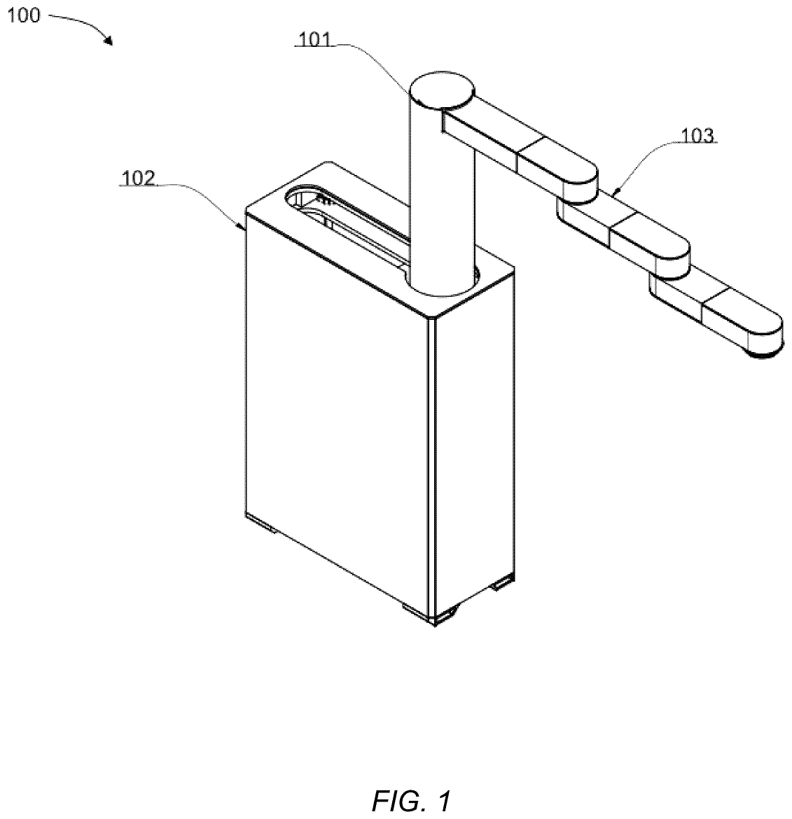

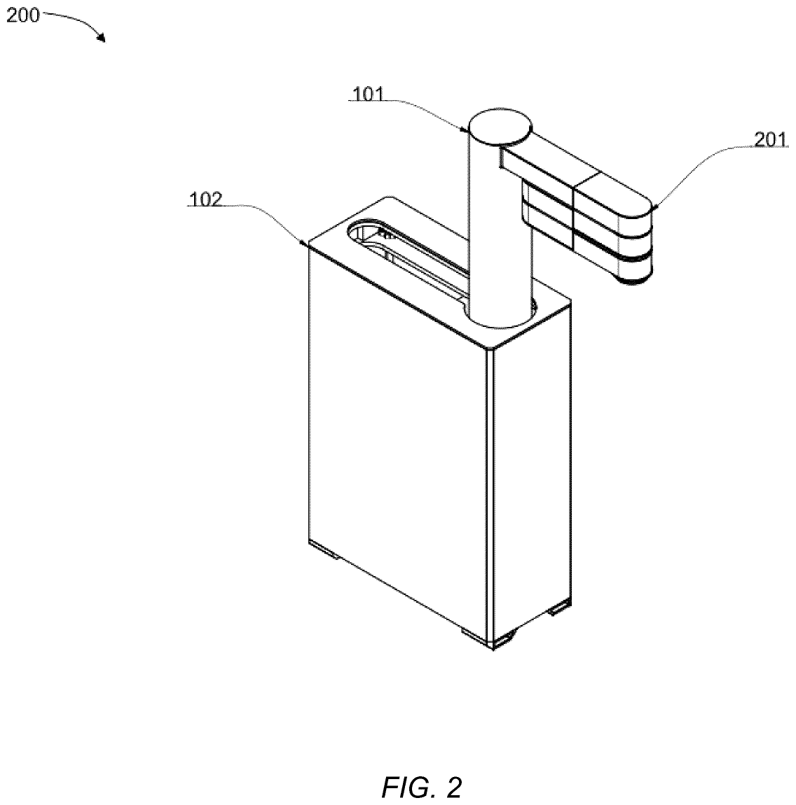

Provided is an automated electromechanical device that uses robotic joints and sensors to apply massages and caresses or “structured touches” on the user's skin, providing therapeutic sensations of comfort and well-being. The present invention is described in detail in the following examples, which may represent more than one embodiment of the invention. A main representation of the therapeutic caress and massage robot is shown in FIGS. 1 and 2.

FIG. 1 is an isometric projection of the caress and massage therapeutic robot in its working or deployed position with the robotic arm fully deployed according to an embodiment of the present invention. In this example, the caress and massage therapeutic robot 100 is shown with the movable upper section—or mast—101 completely extracted from the fixed lower section 102 and the deployable robotic arm 103 with its links fully deployed.

Subsequently, FIG. 2 is an isometric projection of the caress and massage therapeutic robot 100 in its working position with the robotic arm links fully stacked according to an embodiment of the present invention. In this example, the caress and massage therapeutic robot 100 is shown with the deployable robotic arm 103 links fully stacked 201.

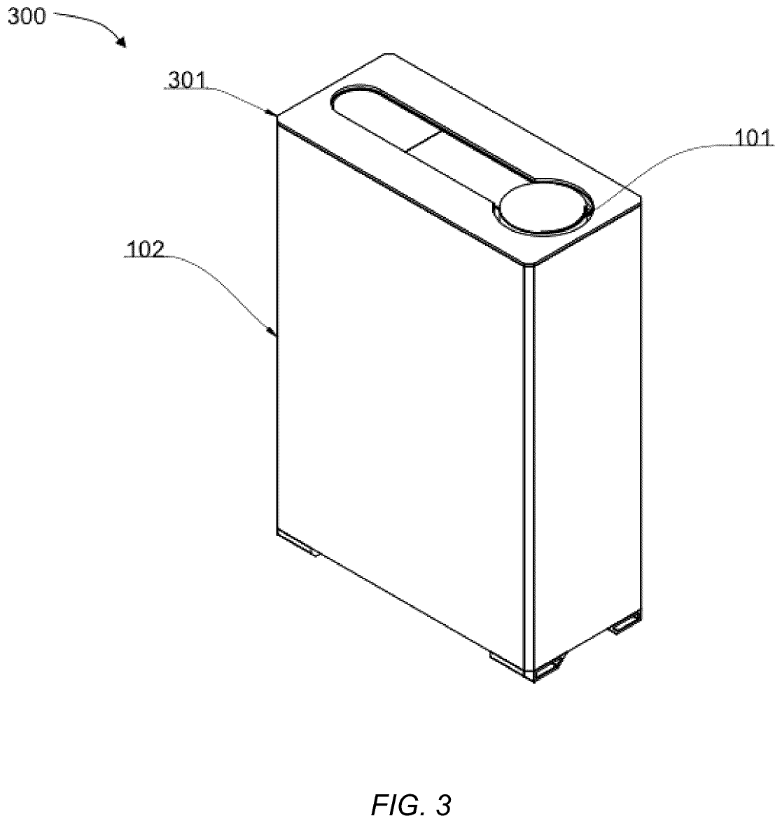

FIG. 3 is an isometric projection of the caress and massage therapeutic robot 100 in stored, or stowed, position according to an embodiment of the present invention. In this regard, an example of the stored, or stowed, position 301 is seen where the movable upper section 101 is completely retracted into the fixed lower section 102.

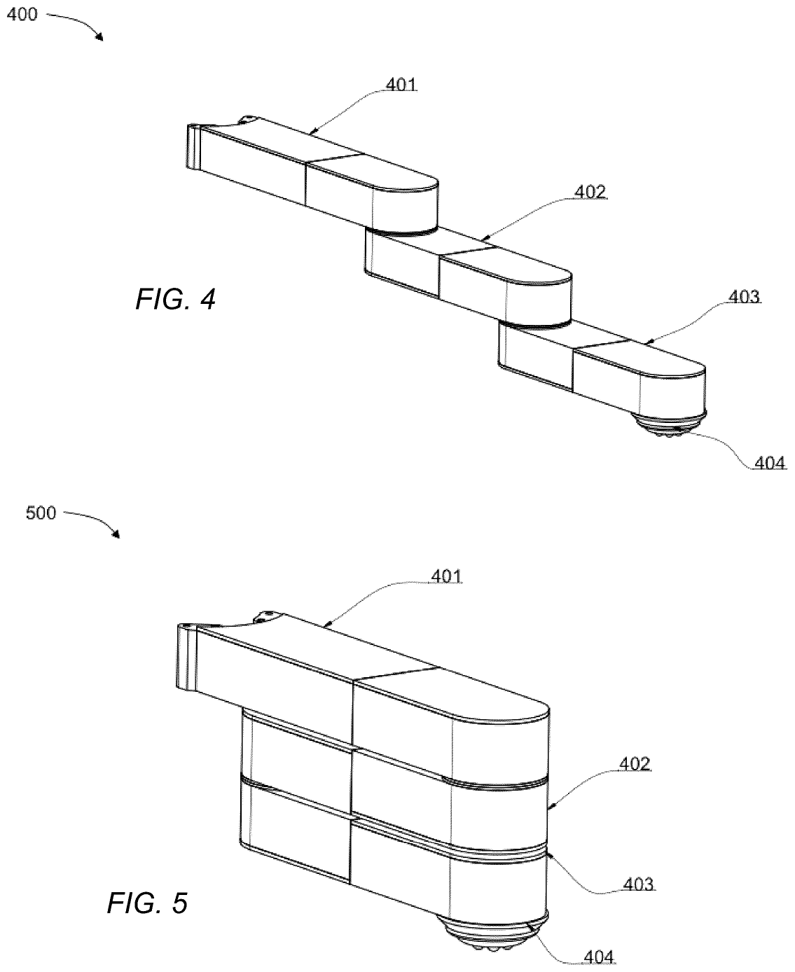

FIG. 4 is an isometric projection of the deployable robotic arm 103 fully deployed according to an embodiment of the present invention. In this example, a Compatible Selective Articulated Robotic Arm (SCARA) type deployable robotic arm 103 is shown with a range of four degrees of freedom (DOF), comprising a fixed link 401 where at least two staggered links, parallel to each other and articulated at their ends 402 and 403 are coupled; at the free end of the last link 403, an effector 404 is housed with a standard coupling where different accessories are attached for transmitting the caress or massage on the user's skin or other work surface assisted by several distance sensors, optical, infrared or laser mapping. Calibration sensors and position sensors are also contained in the articulated end of each link to monitor and control its movement.

In another embodiment of the invention, FIG. 5 is an isometric projection of the fully stacked 201 deployable robotic arm 103. In this example, shown is how each of the links are stacked under the fixed link 401 integrated to the rest of the movable upper section 101.

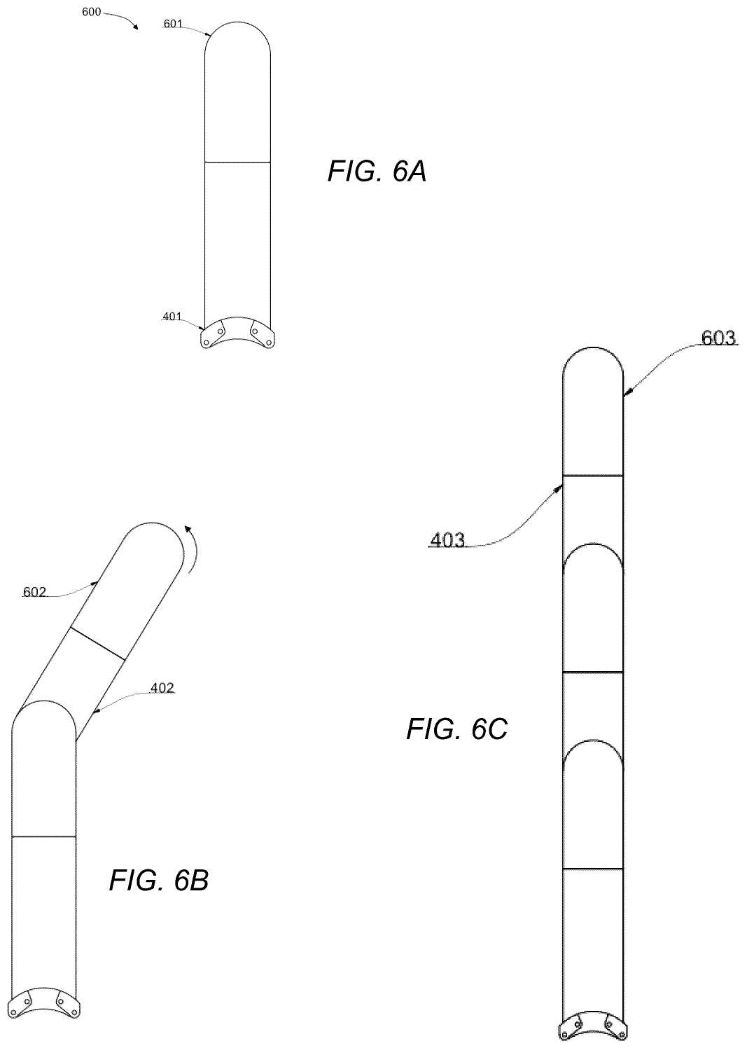

FIGS. 6A, 6B and 6C are sequential top views of the deployable robotic arm 103 demonstrating the deployment process. In this example, the process begins at FIG. 6A with the links in a fully stacked position 201 with only the fixed link 401 integrated to the rest of the movable upper section 101 visible. Next, in the second step (FIG. 6B) the middle link 402 rotates on its own joint until it is parallel to the upper fixed link 401. Finally, in the step 6C, the lower link 403 is placed in parallel to the rest of the links completing the full deployment of the robotic arm 103.

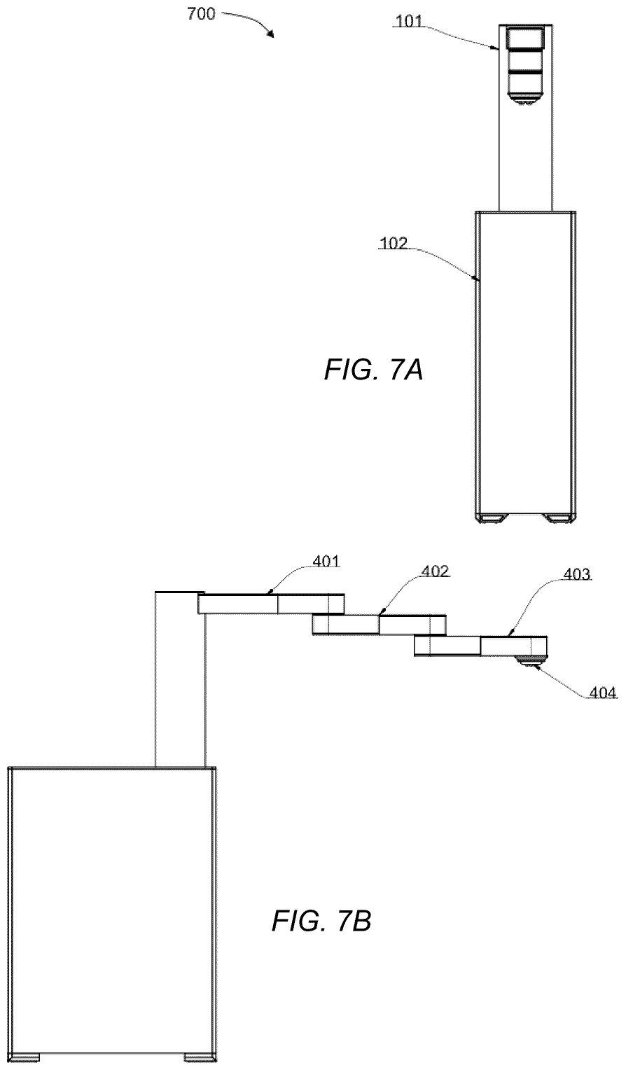

In another aspect of the invention, FIGS. 7A and 7B are, respectively, a side view and a frontal view of the caress and massage therapeutic robot 100 of FIG. 1. In this example, the robot is seen in its working or deployed position.

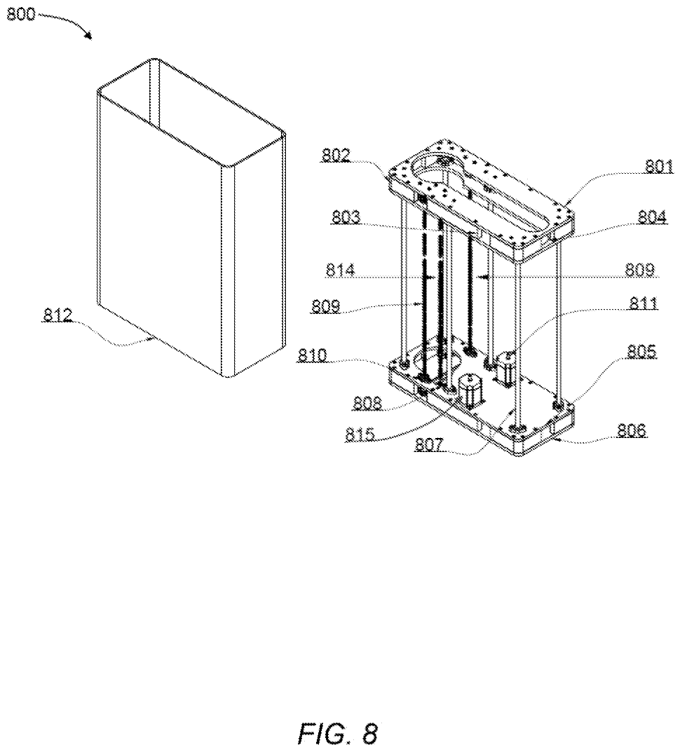

FIG. 8 is an isometric projection of the fixed lower section 102 exposing its main components, according to an embodiment of the present invention. In this representation, the fixed lower section 102 comprises a top surface 801 with an opening therethrough, assembled by corner 802 and side 803 spacers and a set of screws and nuts to a bottom cover 804. On the lower part, a similar arrangement is provided, wherein a top cover 805 is attached through spacers 802 and 803 and a set of screws to the bottom 806—or floor—of the fixed lower section 102; such cover has an opening for housing the upper section vertical axis rotation pulley arrangement. Also, six lineal rod shafts 807 placed on the corners and sides of the fixed lower section 102 provides stiffness and support to the whole structure and are fixed by a set of clamps 808; four of the lineal rod shafts 807 are also used to guide the movable upper section 101 on its vertical movement. Two lower section lead screws 809 on the sides are aligned and fixed to the cover 805 and the bottom 806 by a set of pillow block bearings 810, such led screws are connected to a lower section electrical motor 811 through a double-headed pulley and belt arrangement, for performing the up and down movement of the movable upper section 101. An upper section rotation electrical motor 815 provides movement to a mast rotating lead screw 814 also fixed to the cover 805 and bottom 806 of the fixed lower section 102 by a pair of pillow block bearings 810, this mast rotating lead screw 814 is used to transmit rotational movement to the upper section vertical axis rotation pulley arrangement. The whole structure and components are covered by a sleeve-type case 812.

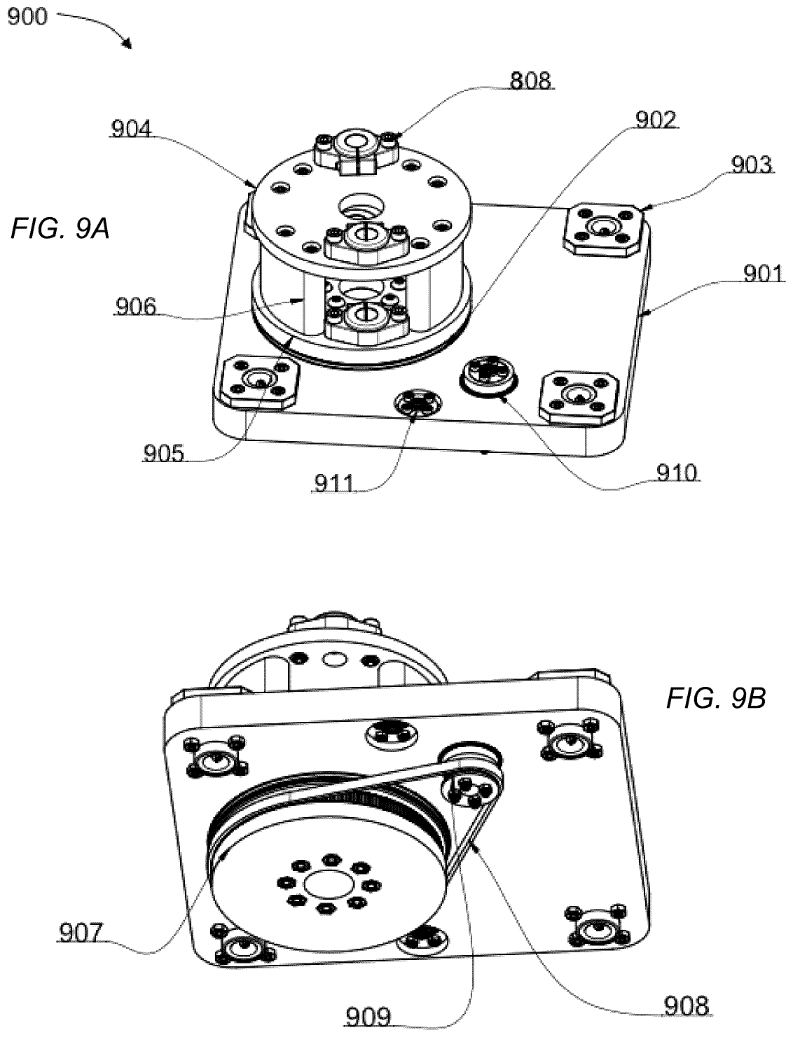

FIG. 9. Is an isometric perspective of the top (9A) and bottom (9B) views of the movable upper section 101 sliding plate 901 and rotating base 902, according to an embodiment of the present invention. In this representation, the top view shows the sliding plate 901 with lineal bearings 903 located on its corners for guiding the up and down sliding movement across the lineal rod shafts 807 located on the fixed lower section 102. Also, the same view exposes the rotating base 902 wherein the movable upper section mast 101 is tightly fixed by a set of clamps 808 placed on a top 904 and bottom 905 covers assembled together by a pair of spacers 906 and set of screws and nuts. The whole base 902 is placed on a rotation mechanism, as shown in the bottom view, comprised by a main pulley 907 embedded on a set of thrust and radial bearings and a flange; such main pulley 907 is connected through a belt 908 to a smaller mechanism arrangement also comprised by a pulley 909 embedded to a radial bearing attached to the sliding plate 901 by means of a flange 910 wherein a lead screw nut 911 is attached for holding the mast rotating lead screw 814 in place. This rotatory movement may also be provided by an upper section rotation electrical motor 815 directly connected to the smaller pulley arrangement mechanism or by changing the mast rotating lead screw 814 for a key-type shaft. Also, another two lead screw nuts, also referred as threaded followers, 911 are placed on the sides of the sliding plate 901 wherein the sideway lower section lead screws 809 are attached.

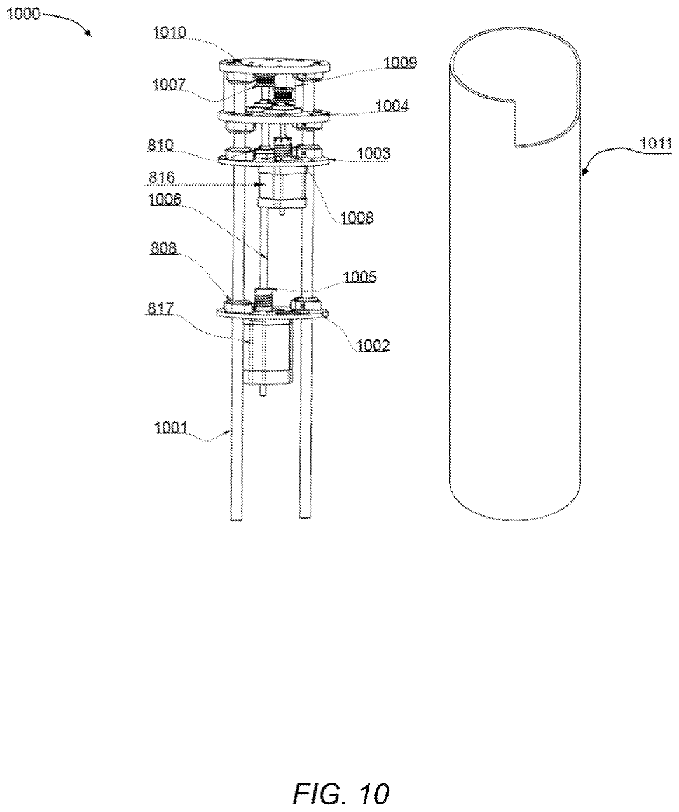

FIG. 10 is an isometric projection of the movable upper section 101, or mast, according to an embodiment of the present invention. In this example, the section comprises two lineal rod shafts 1001 on the sides of the mast fixed by a set of clamps 808 placed on a set of plates 1002, 1003 and 1004 along the shaft's length. On the first plate 1002, a distal joint electrical motor 817 is placed; such distal joint electrical motor 817 has a coupler 1005 with a shaft 1006 supported by a set of pillow block bearings 810 and extended to the upper part of the mast, where a pulley 1007 is located and attached through a belt to the arm joints. A similar arrangement is provided at the following plate 1003, wherein proximal joint electrical motor 816 has a coupler 1005 with a shorter shaft 1008 also supported by a pillow block bearing 810 where another pulley 1007 is placed. Both pillow block bearings 810 are fixed on a plate 1004 wherein also two spacers 1009 are located for supporting the top cover 1010 of the whole movable upper section arrangement. Finally, the whole component arrangement and structure is enveloped by a sleeve-type case 1011 attached with screws.

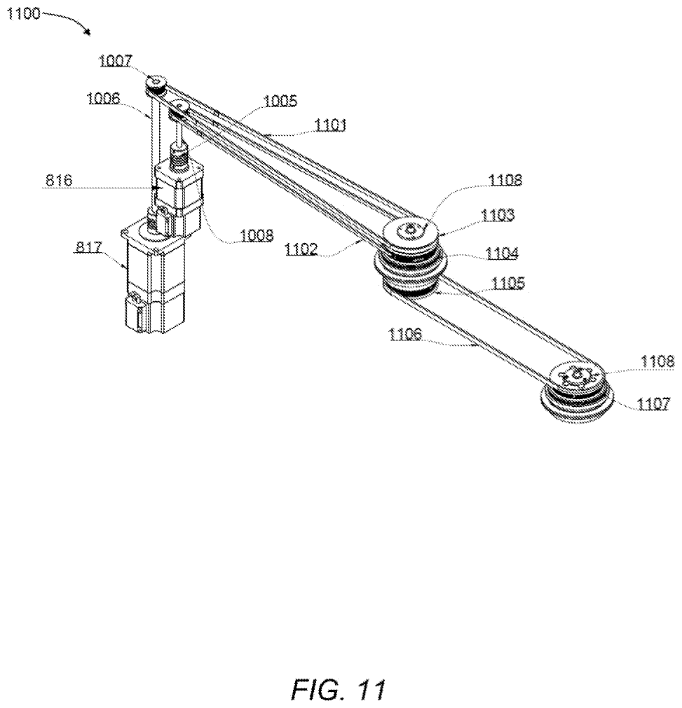

In another aspect of the invention, FIG. 11 shows an isometric projection of the differential power transmission mechanism 1100 inside of the deployable robotic arm 103 links according to an embodiment of the present invention. In this example, it is illustrated how the distal joint electrical motor 817 and the proximal joint electrical motor 816 contain extension shafts 1006 and 1008 attached to pulleys 1007 on their shafts to which belts 1101 and 1102 are connected, said belts are coupled to pulleys 1103 and 1104, respectively. After passing through the concentric hollow shafts and axial/radial bearings arrangement, the angular velocity of the pulley 1103 is transmitted to its twin pulley 1105 in which another belt 1106 is connected transmitting the power to a last and similar power transmission mechanism set where the pulley 1107 is located. In both transmission mechanisms, slip rings 1108 are embedded for guiding the power and control cables through the hollow shafts to the several sensors and other components located on the arm links.

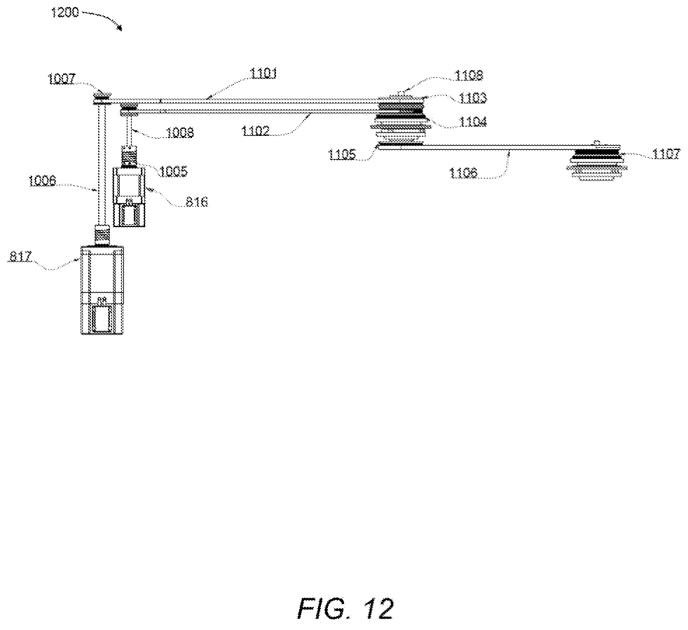

According to another aspect of the invention, FIG. 12 illustrates a side view of the differential power transmission mechanism of FIG. 11 in which the pulleys and belts arrangement is fully detailed.

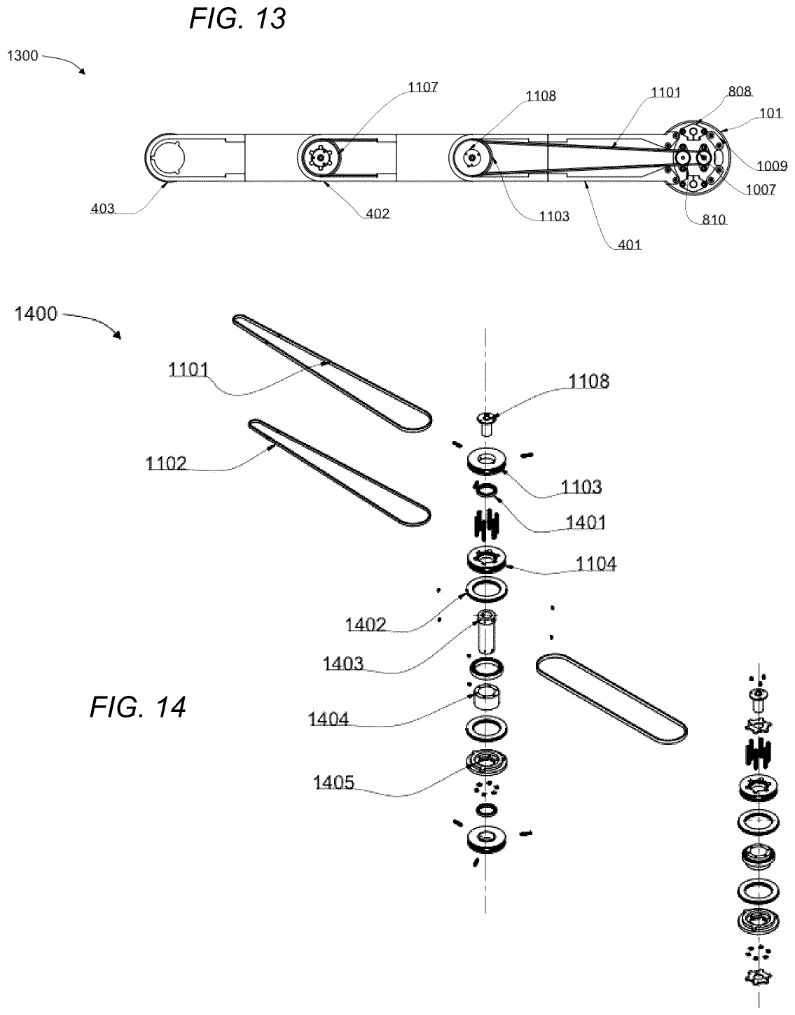

FIG. 13 is a top view of the differential power transmission mechanism of FIG. 11 also showing the position of its various components within the links of the deployable robotic arm 103. In this embodiment of the invention, an example of how the power transmission mechanism is arranged in the fixed upper link 401, and middle 402, and lower 403 links of deployable robotic arm 103, respectively, is given.

FIG. 14 is an exploded view of the pulley arrangement used in the differential power transmission mechanism 1100 of the deployable robotic arm 103 links, according to an embodiment of the present invention. Through this perspective, each of the mechanism components previously introduced in FIG. 11 are illustrated in a cleaner and more detailed way. Also, the set of radial 1401 and axial 1402 bearings are shown within the hollow shafts 1403 and 1404 that are used to transmit the rotational movement to the next link connected by a flange 1405. Same concept is implemented in the secondary power transmission mechanism.

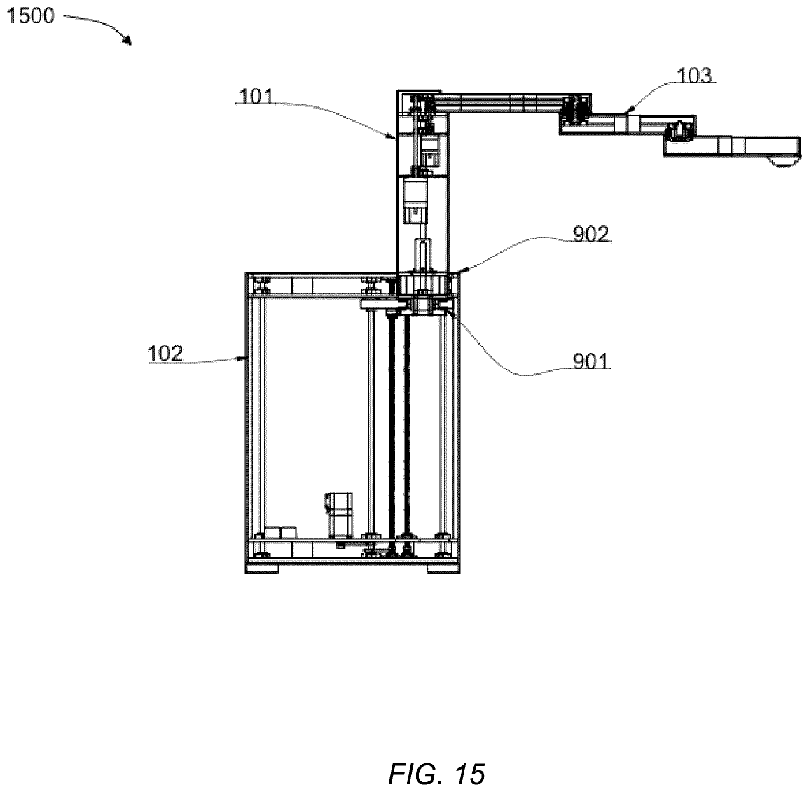

In another aspect of the invention, FIG. 15 is a cross-sectional side view of the caress and massage therapeutic robot 100 as shown in FIG. 7B. Through this perspective, each of the device sections and components, as the movable upper section 101, the fixed lower section 102, the deployable robotic arm 103, the movable upper section sliding plate 901 and rotatory base 902, introduced in the previous figures are illustrated in a cleaner and more detailed way.

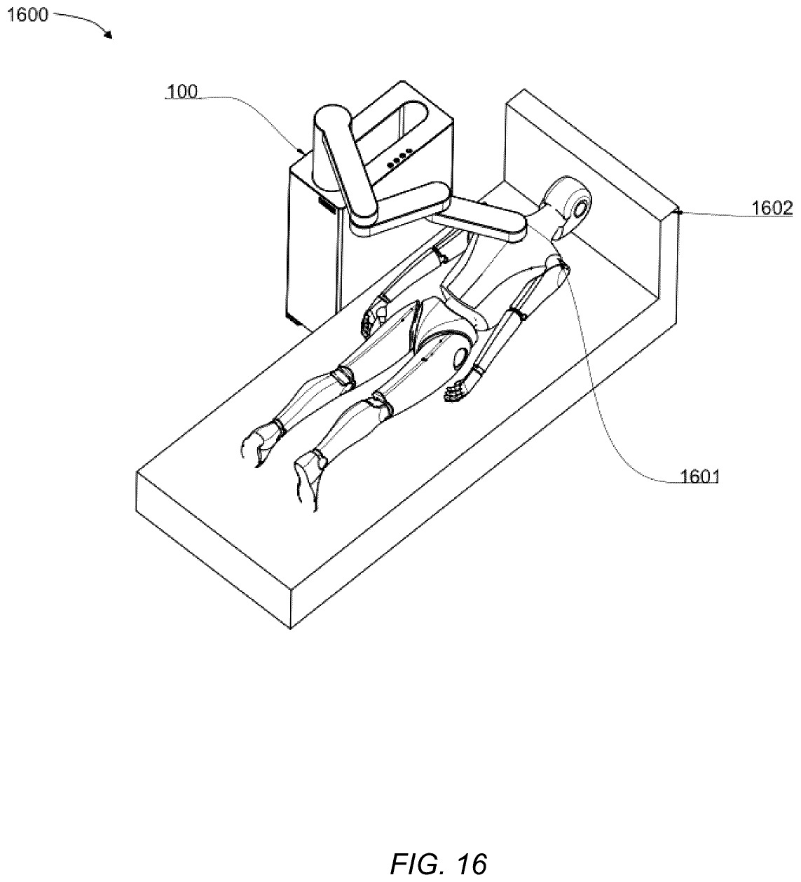

In another aspect of the invention, FIG. 16 is an isometric projection of the caress and massage therapeutic robot 100 of FIG. 1 using the deployable robotic arm 103 effector 404 to apply a massage to the back of a user 1601 lying on a bed 1602.

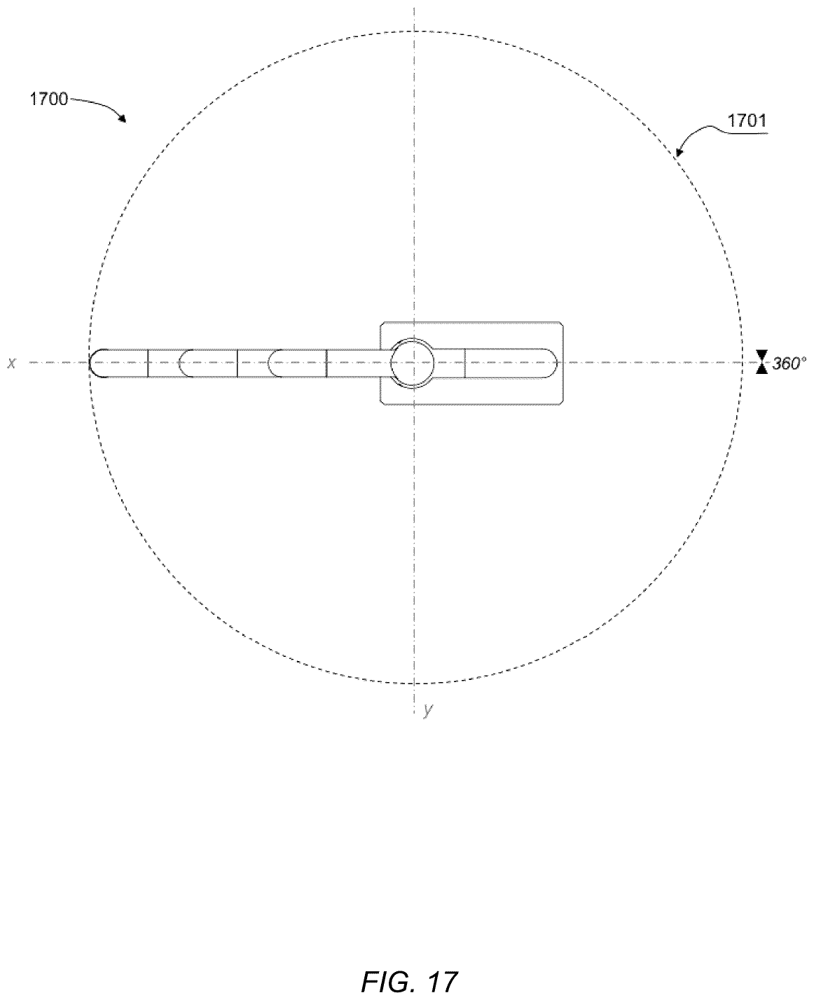

In another aspect of the invention, FIG. 17 is a schematic representation of a top view of the therapeutic caress and massage robot of FIG. 1 describing its range of work area or workspace 1701 when all the links of the deployable robot arm 103 are parallel to the x-axis, achieving a maximum workspace range of 360° around the apparatus.

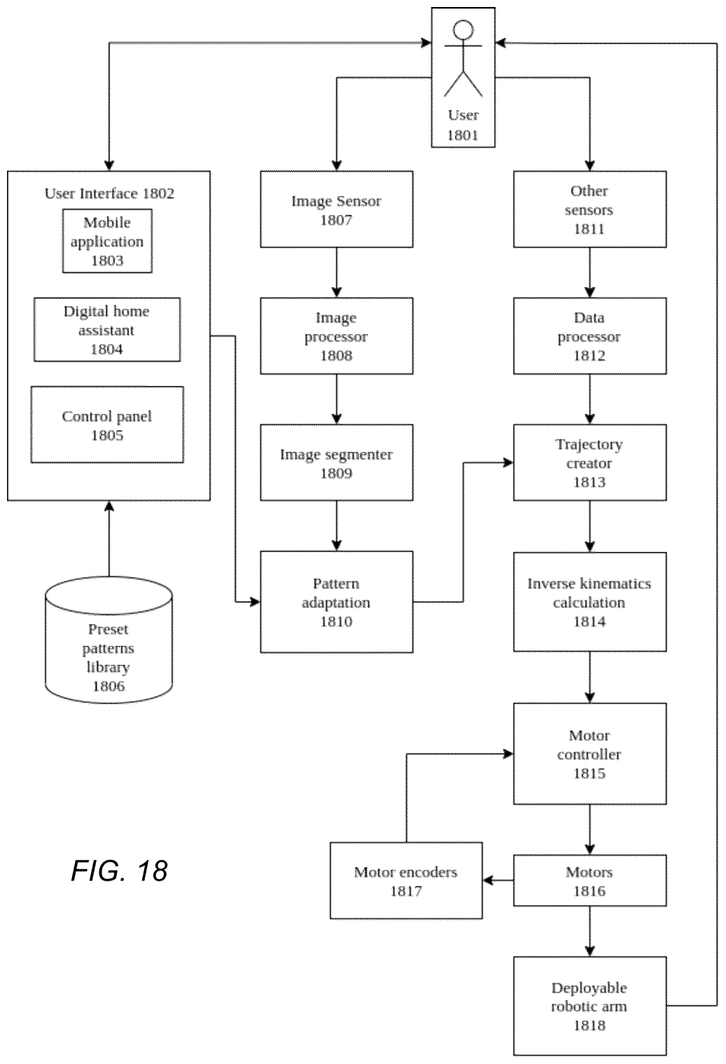

Next, FIG. 18 shows a process flow diagram illustrating the method for applying massages and caresses on the user's skin, according to an embodiment of the present invention. The method 1800 starts with a user 1801 using a user interface (UI) 1802, that could be embodied in a mobile application (“app”) 1803, a digital home assistant 1804, a control panel on the robot 1805 or any other type of user interface to initialize the massage process and choose one of the patterns available in the library of preset massage and caress patterns 1806, which is stored in a database in a non-volatile memory in the circuit, in the mobile application 1803 or in a remote server (“cloud”).

The method continues with collecting the necessary information to create a digital image with the image sensor 1807, which can be a regular camera, a thermal image camera, a Laser Imaging Detection and Ranging (LIDAR) sensor or any other sensor capable of creating digital images. This information passes through an image processor 1808, which is responsible for processing the information received and converting it into relevant data for the image segmenter 1809, whose function is to categorize the relevant areas of the image assisted by artificial intelligence (AI), visual classification algorithms, or any another method that allows image segmentation. The image segmenter 1809 recognizes and isolates an image from the back of the user 1801, then it adapts the pattern 1810 previously selected by the user 1801 to the scale and contour of the segmented image.

Still referring to FIG. 18, in parallel, the other sensors 1811 collect other data from the user 1801 and the environment. The sensors 1811 can measure distance, pressure, temperature or any other type of parameters. The information collected is sent to the data processor 1812, which is responsible for converting the signals from the sensors 1811 into useful information by filtering the parameters either by gathering values from the measurement sensors or using software filtering algorithms.

A path creator 1813 uses the information from the data processor 1812 and the pattern adaptation 1810 to create a trajectory adjusted to the data collected. This path describes the trajectory that the deployable robot arm 1818 effector must perform. Next, the inverse kinematics calculation 1814 of the pattern is performed, computing the angles that each joint of the deployable robotic arm 1818 must have as a function of time for the effector to perform the desired path.

Finally, still referring to FIG. 18, the motor controller 1815 transforms the angles calculated for each point of the trajectory into signals that the motors 1816 can read, and in turn, continuously receives information from the motor encoders 1817 about the status of the motors 1816, correcting their angles with continuous feedback, allowing a precise movement of the deployable robotic arm 1818 and applying the pattern movements on the user 1801.

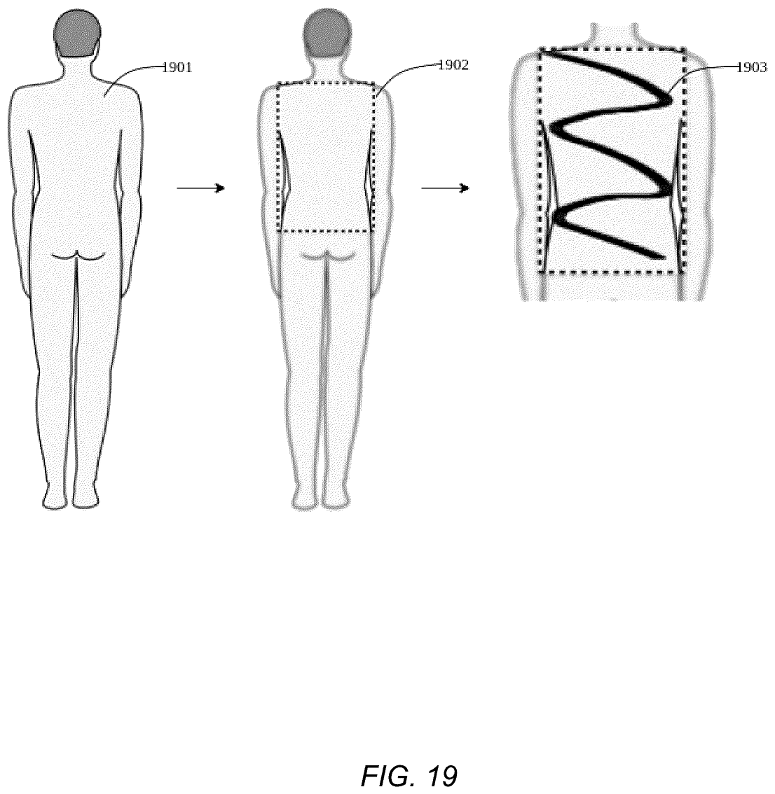

FIG. 19 comprises a process flow diagram illustrating the image segmentation process used in the method for applying massages and caresses on the user's skin, according to an embodiment of the present invention. First, the method 1900 starts with collecting the necessary information to create a digital image 1901 of the user 1801 through the image sensor 1806; next, the artificial intelligence (AI) assisted image segmenter 1808 classifies the user's 1801 pose, identifying whether the user 1801 is facing back or front, and then segments the area that will receive the massage 1902. Finally, the software adapts the selected pattern 1903 to the scale and contour of the segmented image 1902.

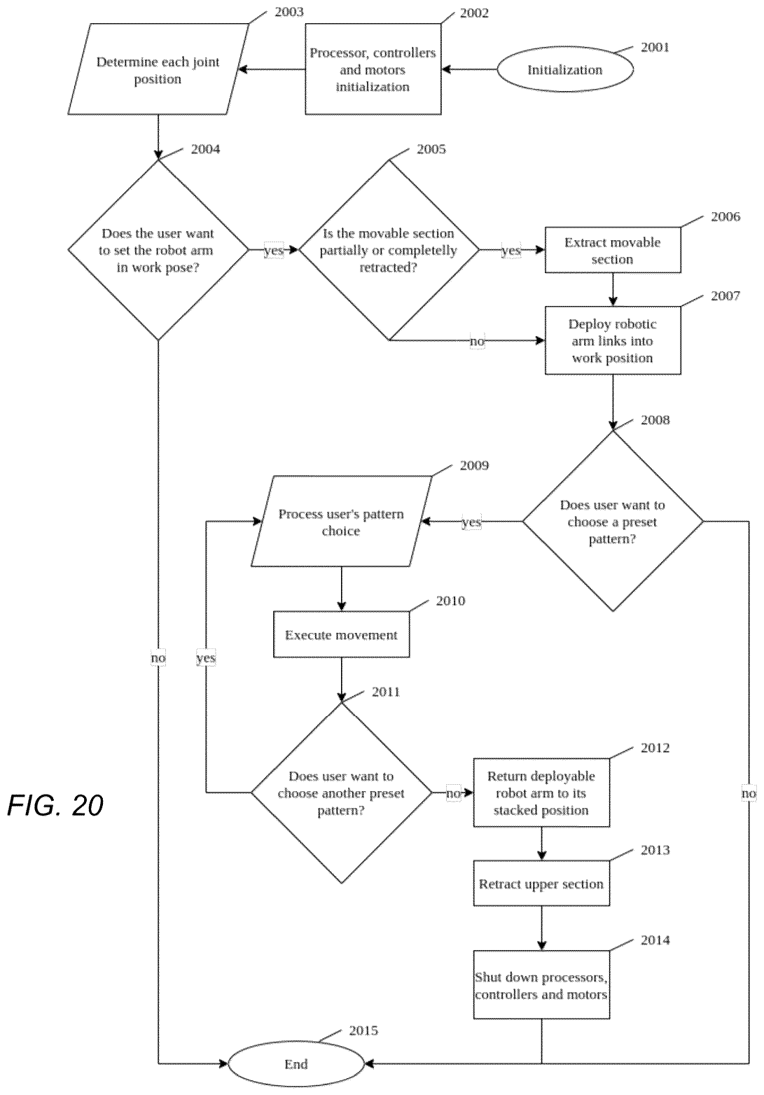

FIG. 20 comprises a process flow diagram illustrating the method for controlling the several motors of the massage and caress therapy robot, according to an embodiment of the present invention. The method includes the necessary steps to bring the robot from its stored position, with the deployable robotic arm fully stacked on itself and the upper section, or mast, fully retracted inside the lower section, to the working position with the upper section fully extracted and the robot arm fully deployed.

Referring to FIG. 20, the device is initialized 2001 by the user 1801 through the user interface 1802; with this action, the processors, controllers and motors are initialized 2002. Next, the position. of each joint of the deployable robotic arm is determined 2003 through the motor encoders 1817 and position sensors 1811. Then, upon receiving a positive instruction 2004 from the user 1801, the method. proceeds to verily whether the movable section is partially or completely retracted 2005; if this is the case, the movable section will be completely extracted to its working position 2006, also deploying the links of the robotic arm 2007 into work position,

User 1801 is then prompted to select a preset pattern 2008, which is processed. 2009 and executed 2010; on the other hand, if the does not to select a pattern 2011, the deployable robot arm returns to its stacked position 2012 and the upper section is retracted 2013; finally, the processors, controllers, and motors are deactivated 2014, providing for the end 2015 of the method.

It will be apparent to one with skill in the art that the caress and massage therapeutic robot of the invention may be provided using some or all of the mentioned features and components without departing from the spirit and scope of the present invention. It will also be apparent to the skilled artisan that the embodiments described above are specific examples of a single broader invention which may have greater scope than any of the singular descriptions taught. There may be many alternations made in the descriptions without departing from the spirit and scope of the present invention. The scope of the present invention should, therefore, be determined only by the following claims.

1. A robotic caress and massage apparatus, comprising:
a fixed lower section comprising a top surface, and a floor, the top surface comprising an opening therethrough;
a movable upper section, comprising a base and a vertical axis, the movable upper section adapted to fully retract within the fixed lower section and to emerge vertically from the fixed lower section through the opening on the top surface of the fixed lower section, the movable upper section further adapted to rotate about the vertical axis relative to the fixed lower section;
a selective compliant articulated robotic arm comprising a plurality of links that descend vertically in height, one or more of the plurality of links adapted to rotate about an axis parallel to the vertical axis;
an effector removably attached to the selective compliant articulated robotic arm; and
a movable upper section lifting mechanism adapted to translate the movable upper section vertically with respect to the fixed lower section between a stowed configuration and a deployed configuration.

2. The robotic caress and massage apparatus of claim 1, wherein the movable upper section lifting mechanism comprises:
a lower section lead screw extending vertically from the floor of the fixed lower section;
a selectively activated lower section electrical motor attached to the fixed lower section, and adapted to rotate the lower section lead screw upon activation; and
a threaded follower attached to the movable upper section adapted to engage the lower section lead screw.

3. The robotic caress and massage apparatus of claim 2, further comprising:
an upper section mast rotating base main pulley attached to the base of the movable upper section;
an upper section rotation electrical motor attached to fixed lower section in driving engagement with a mast rotating lead screw;
a mast rotating base small pulley engaged with the mast rotating lead screw; and
an upper section rotation belt adapted to engage the mast rotating base small pulley and the upper section mast rotating base main pulley;
wherein upon activation of the upper section rotation electrical motor, a rotational motion about the vertical axis is imparted on the movable upper section through the upper section rotation belt.

4. The robotic caress and massage apparatus of claim 3, wherein the selective compliant articulated robotic arm comprises:
an upper link having a proximal end and a distal end;
a middle link having a proximal end and a distal end;
a lower link having a proximal end and a distal end;
wherein the proximal end of the upper link is adapted to engage the movable upper section;
wherein the distal end of the upper link and the proximal end of the middle link form a proximal joint configured to allow the middle link to rotate about an axis of the proximal joint;
wherein the distal end of the middle link and the proximal end of the lower link form a distal joint configured to allow the lower link to rotate about an axis of the distal joint; and
wherein an effector is attached to the distal end of the lower link.

5. The robotic caress and massage apparatus of claim 4, wherein the selective compliant articulated robotic arm further comprises:
a proximal joint electrical motor attached to the movable upper section;
a proximal joint pulley attached to the proximal joint; and
a proximal joint belt adapted to engage the proximal joint electrical motor and the proximal joint pulley;
wherein upon activation of the proximal joint electrical motor, a rotational motion is imparted on a middle joint about the axis of the proximal joint through the proximal joint belt.

6. The robotic caress and massage apparatus of claim 5, wherein the selective compliant articulated robotic arm further comprises:
a distal joint electrical motor attached to the movable upper section;
an intermediate distal joint pulley attached to the proximal joint;
a terminal distal joint pulley attached to the distal joint;
an intermediate distal joint belt adapted to engage the distal joint electrical motor and the intermediate distal joint pulley; and
a terminal distal joint belt adapted to engage the intermediate distal joint pulley and the terminal distal joint pulley;
wherein upon activation of the distal joint electrical motor, a rotational motion is imparted on a lower joint about the axis of the distal joint through the intermediate and terminal distal joint belts.

7. The robotic caress and massage apparatus of claim 6, further comprising:
a deployment controller for selectively activating the lower section electrical motor to translate the movable upper section between the stowed configuration and the deployed configuration.

8. The robotic caress and massage apparatus of claim 7, further comprising:
one or more robot arm controllers for selectively activating one or more of the upper section vertical electrical motor, upper section rotation electrical motor, proximal joint electrical motor, and the distal joint electrical motor to sequentially position the effector to make contact with the skin of the user.

9. The robotic caress and massage apparatus of claim 8, further comprising:
one or more processors adapted to control the deployment controller and the one or more robot arm controllers;
a memory adapted to store instructions for controlling the deployment controller and the one or more robot arm controllers; and
a user interface for directing the one or more processors to operate the deployment controller and the one or more robot arm controllers in accordance with the instructions stored in the memory.

10. The robotic caress and massage apparatus of claim 8, further comprising delivering a massage or caress to the user.

11. A method for using a robotic caress and massage apparatus, the method comprising:
raising a movable upper section within a fixed lower section using a movable upper section lifting mechanism, wherein the fixed lower section is raised vertically through an opening on a top surface of a fixed lower section from a stowed configuration;
rotating the movable upper section about a vertical axis relative to the fixed lower section to a deployed configuration;
rotating one or more links of a selective compliant articulated robotic arm about an axis parallel to the vertical axis, the robotic arm comprising a plurality of links descending vertically in height; and
positioning an effector removably attached to the selective compliant articulated robotic arm with respect to an anticipated user.

12. The method of claim 11, wherein translating the movable upper section further comprises:
rotating a lower section lead screw extending vertically from the floor of the fixed lower section using a selectively activated lower section electrical motor attached to the fixed lower section; and
engaging the lower section lead screw with a threaded follower attached to the movable upper section.

13. The method of claim 12, further comprising:
imparting rotational motion about the vertical axis on the movable upper section using an upper section rotation electrical motor, wherein the rotational motion is applied to a upper section mast rotating base main pulley attached to the base of the movable upper section, and wherein the upper section rotation electrical motor is attached to the fixed lower section; engaging the fixed lower section with a mast rotating lead screw, the mast rotating lead screw being engaged with the mast rotating base small pulley; and
engaging the mast rotating base small pulley and the upper section mast rotating base main pulley using an upper section rotation belt.

14. The method of claim 13, further comprising:
rotating an upper link, a middle link, and a lower link of the selective compliant articulated robotic arm, each of the upper link, middle link, and lower link having proximal and distal ends, wherein the proximal end of the upper link being is engaged with the movable upper section, the distal end of the upper link and the proximal end of the middle link form a proximal joint, and the distal end of the middle link and the proximal end of the lower link form a distal joint;
rotating the middle link about an axis of the proximal joint; and
rotating the lower link about an axis of the distal joint.

15. The method of claim 14, further comprising:
imparting rotational motion on a middle joint about the axis of the proximal joint by activating a proximal joint electrical motor attached to the movable upper section; and
engaging a proximal joint pulley using a proximal joint belt and the proximal joint electrical motor.

16. The method of claim 15, further comprising:
imparting rotational motion on a lower joint about the axis of the distal joint by activating an distal joint electrical motor attached to the movable upper section, the proximal joint being attached to an intermediate distal joint pulley and the distal joint being attached to a terminal distal joint pulley;
engaging the intermediate distal joint pulley using the distal joint electrical motor and an intermediate distal joint belt;
engaging the terminal distal joint pulley using a terminal distal joint belt with the intermediate distal joint pulley; and
wherein the rotational motion on the lower joint about the axis of the distal joint is further imparted using the intermediate distal joint belt and the terminal distal joint belt.

17. The method of claim 16, further comprising:
activating the lower section electrical motor using a deployment controller to translate the movable upper section between the stowed configuration and the deployed configuration.

18. The method of claim 17, further comprising:
sequentially positioning an effector to make contact with the skin of the user by activating one or more robot arm controllers, wherein the one or more robot arm controllers is configured to selectively control the upper section rotation electrical motor, the proximal joint electrical motor, and the distal joint electrical motor.

19. The method of claim 18, further comprising:
controlling the deployment controller and the one or more robot arm controllers using one or more processors adapted to execute instructions stored in a memory.

20. The method of claim 19, further comprising:
directing the one or more processors via a user interface to operate the deployment controller and the one or more robot arm controllers in accordance with the stored instructions to deliver a massage or caress to the user.
